(19) United States
(12) Patent Application Publication
(10) Pub. No.: US 2003/0216164 A1
(43) Pub. Date: Nov. 20, 2003

(54) Validation of instant win lottery tickets

(76) Inventor: Lyle Harold Scrymgeour, Winnipeg (CA)

Correspondence Address: ADE & COMPANY, 1700-360 MAIN STREET, WINNIPEG, MB, R3C3Z3, CA

(21) Appl. No.: 10/143,825

(22) Filed: May 14, 2002

(51) Int. Cl. A63F 13/00

(52) U.S. Cl. 463/17; 463/42

(57) ABSTRACT

The validation of an allegedly winning ticket from a series of instant win lottery tickets includes providing on each ticket of the series a validation number or VIRN unique to the ticket which is printed on the ticket in machine readable format, preferably a bar code format and covered by a scratch-off layer. The VIRN is read by a scanner of a validation terminal operated by an agent and is compared at a data source with a list of the validation numbers of the winning tickets in association with a predetermined prize value of the associated ticket. The validation process is enhanced by causing a display screen of the terminal to communicate the requirement to the agent for input into a key pad of required information from the alleged winning ticket including a confirmation of inspection of the validity of the ticket and a game number read from the ticket.

The present invention relates to a method of validating instant win lottery tickets for redemption, that is payment of a prize associated therewith when presented as allegedly winning tickets.

### BACKGROUND OF THE INVENTION

Since the first introduction of instant tickets, regardless of the style, there has been ongoing development of a variety of means to validate a winning ticket prior to redemption. One example of the concept of using a separate validation number for lottery tickets is described in U.S. Pat. No. 4,191,376 Goldman et al. which was filed in 1977.

Shortly thereafter, it became common practice to place the validation information under scratch-off. Initially this was in a separate box entitled a VIRN (Void if Removed Number) and subsequently was placed within the same box as the game symbols covered with the same scratch-off material.

Like other companies within this industry, the assignees of the present application Pollard has been active in development of validation alternatives and incorporated different formats for scratch-off and pull tabs version of the instant ticket. The first validation system introduced by Pollard was on a pull-tab style instant ticket. In this case the ticket featured game indicia printed on one side of the ticket in a variety of different configurations with winners having 3 of the same symbol in a single row. Pollard did develop a validation coding scheme in which different codes were assigned to winning and losing tickets. The code was printed on the outside of the ticket, on the opposite side to the game indicia and was covered by removable scratch-off. There were two primary functions for this code. The first was to prevent ticket splitting (that is removal of the front laminate of the ticket and subsequent application of a different front laminate from another unit) and the second was to validate the winning/losing status of the game indicia.

Subsequent to this development, Pollard incorporated a variety of different means to provide for validation of instant tickets, whether pull-tab or scratch-off. In each case the information required to validate the winning losing status of the ticket was covered with a removable layer.

Traditionally, there have been two styles of instant lottery tickets in common use within the gaming/lottery industry. Both styles of ticket are very similar in terms of playability, etc. and each features a removable layer with winning/losing game indicia printed beneath.

Beginning on line 6 column 2 of U.S. Pat. No. 4,398,708, Goldman et al., there is a description of instant lottery tickets, “the lottery number (or other indicia) printed on the ticket is concealed, e.g., by an opaque covering such as paper than can be tom off to reveal the number, or a removable coating or metal foil that covers the number”. This patent was one of the definitive patents within the lottery industry and is referred to many times in subsequent patent applications and patents.

International Gameco, an instant ticket manufacturer, located in Omaha, Nebr. did develop and introduce their “Scanline Validation System” in 1993/94. This instant ticket did feature a validation barcode located under a removable coating. The functionality of the system, is described in a brochure (dated August 1994).

Similarly, in U.S. Pat. No. 5,290,033, Bittner et al, beginning at line 48 column 3, there is described an instant lottery which “more specifically, back side of 108 of playing portion 106 is encoded with a digital, machine-readable barcode 114. Barcode 114 allows a pull-tab machine, when equipped with a bar-code reader as described below to determine both the validity of the game coupon and the number of prize credits with which the player should be credited”. The barcode described in this patent utilizes a standard format such as “interleaved two of five”.

Further in the Bittner patent, beginning on line 59 column 8, Bittner anticipates the same concept in other types of gaming products “One possible application is with popular lottery games in which lottery tickets are presently purchased and subsequently redeemed from a cashier”. This reference is to an instant lottery ticket, with a scratch-off coating in place of the pull-tab.

Thus many companies have been utilizing the practice of placing ticket validation information under scratch-off either in a separate box or within the game area for a number of years. In the majority of cases this information was printed in a human readable font which was designed to be read by the ticket agent during the winner redemption process.

However, prior to 1994, there were examples of instant scratch-off lottery tickets which featured the validation information in an OCR A or similar font. OCR (Optical Character Recognition) is a machine-readable font similar to a barcode, which is also a machine readable font.

One example of this concept is the “Win for Life” ticket”, produced by Webcraft Games for the Connecticut Lottery in 1982. This particular ticket featured a Book/Ticket VIRN in OCR A. Apparently the same concept was used on subsequent games thereafter.

A second example is the “Money Maker” ticket produced by Scientific Games for the Illinois State Lottery in 1985. This ticket featured an 8 digit validation number in an OCR A font.

A third example is two tickets produced for the Pan-Malaysian Lottery. The “Big Sweep” lottery in an ongoing series produced by Pacific Security Systems (a division of OGT) in 1993 in Australia. Pollard also produced tickets with the same OCR A feature in Canada in the same time frame. Like the above Connecticut and Illinois examples these tickets featured the validation and book/ticket numbers in an OCR A font. The validation process however is identical to the use of a bar code in that the ticket is scanned and the information is then forwarded electronically to a central processor to determine if the information is contained on a predetermined list. Many of the scanners in the marketplace will read either format interchangeably.

Another example of a VIRN is shown in U.S. Pat. No. 5,074,566 (Desbiens) assigned to OGT which shows the “void if removed” scratch-off layer covering a validation number in FIG. 3.

OGT also obtained grant of U.S. Pat. No. 6,308,991 (Royer) in 2002 based upon an application filed on Oct. 16, 1995. This patent is based on their claim to have invented an alternative means to authenticate an instant lottery ticket. The OGT patent claims to effect authentication of the lottery ticket simply by scanning a bar code which contains “all information necessary to authenticate the ticket”. The patent also states that the authentication occurs “without the input of additional information provided by the agent or the printed document or directly from the printed document”. However this is not correct since the process carried out on the OGT ticket does not act to authenticate the ticket itself but merely provides an indication that the particular bar code is associated with a particular prize. If the barcode presented is therefore printed on a simple paper substrate which is not itself a ticket than the reading of the barcode will have no ability to authenticate the ticket. Thus the tickets itself may be entirely counterfeit, fabricated by a ticket purchaser or by the agent and the process set forth in this patent will fail to identify the counterfeit and is not therefore an authentication process.

### SUMMARY OF THE INVENTION

It is one object of the present invention to provide an improved method for confirmation of a prize to be paid on an allegedly winning instant lottery ticket.

According to the invention there is provided a method comprising:

providing a series of instant win lottery tickets having game indicia thereon for playing by a player, the tickets being associated together as a game identified by a game number printed on each ticket of the series, some of the tickets being winning tickets having a predetermined prize value and some of the tickets being losing tickets;

providing on each ticket of the series a validation number unique to the ticket which is printed on the ticket in machine readable format;

providing a data source having for all the winning tickets a list of the validation numbers in association with a predetermined prize value of the associated ticket;

in the event that an alleged winning ticket is presented for payment of a prize by a player, causing an agent to receive the alleged winning ticket;

providing a validation terminal;

providing at the terminal having a scanner for reading the validation number in machine readable format;

providing at the terminal a communications link to the data source;

providing at the terminal a manual input device operable by the clerk to enter information;

providing at the terminal an output device for communicating information to the agent;

causing the agent at the terminal to scan the ticket using the scanner to read the validation number;

causing the output device to communicate information to the agent requiring input of required information from the alleged winning ticket;

and, only upon receipt of the required information and upon the scanned validation number properly appearing on the list of winning tickets at the data source, authorising payment to the player of the predetermined prize value associated with that validation number.

In most cases, the input device will comprise a manual key pad, particularly one having number input keys, but it will be appreciated that other types of input may be possible for the agent to enter the required information.

In most cases, the input device will comprise a display screen which is used to prompt the agent to enter the required information by way of a displayed message. However other forms of prompt including spoken or simulated voice, or simple illuminated display lights may be used.

The validation number identified above may form part of additional information including the game number, the book number and optionally the ticket number.

The required information is used to supplement the scanned information. It will be appreciated that the machine readable code or bar code may be provided simply on a photocopied or printed sheet which is counterfeit and the machine will have no ability to determine this. Thus the present invention prompts the agent to provide the required information as a separate and additional information to supplement the machine read validation number. In one arrangement, the required information may comprise a number printed on the ticket. In other arrangements, the information may be more complex or the information may be more specific to an anti-counterfeiting symbol or visual feature printed specially on the ticket. Thus the agent, if dishonest, may scan printed bar codes from many sources in the hope of hitting a winning number. The requirement to provide additional information from the ticket will prevent the agent from obtaining an authorisation for payment of a winning bar code unless the ticket with its additional information is also in front of the agent for study at the time of scanning the bar code.

Generally, the game number will not be entered as it will be contained in the barcode. The barcode will contain the game number, book number, validation number and may include ticket number. During the validation process, the central system will first look up the book number on the good book list for that specific game number (ensures that the book is not a void and not stolen). If the book number is legitimate then it will look up the validation information, for that game number, associated with the validation number from the ticket.

In another more simple arrangement, the required information is a confirmation that the agent has inspected the ticket and confirms that it appears on its face to be a valid ticket. While this may appear to be something the agent would undertake in any event, it is believed to be important to specifically trigger the agent to undertake a visual inspection of the presented allegedly winning ticket in what otherwise might become a purely routine process of scanning pieces of paper with the assumption that the machine is able to authenticate the ticket from the scanned number, which it is not. Thus the agent, if poorly motivated, without this prompt may merely scan any substrate carrying the required bar code without considering whether it should be scanned at all. In this arrangement, the required information may also include other information, such as a number printed on the ticket, which must also be read or found from the ticket by the agent.

Preferably the validation number is a void if removed number (VIRN) covered by a scratch-off layer.

### BRIEF DESCRIPTION OF THE DRAWINGS

Embodiments of the invention will now be described in conjunction with the accompanying drawings in which:

FIG. 1 is a schematic front elevational view of a lottery ticket for use in the present invention.

FIG. 2 is a schematic illustration of a validation terminal for use in the present invention.

FIG. 3 is one example of a series of display screens shown to the agent during validation of a lottery ticket in accordance with the present invention.

In the drawings like characters of reference indicate corresponding parts in the different figures.

### DESCRIPTION OF THE PREFERRED EMBODIMENTS

An example of a lottery ticket is shown schematically in FIG. 1 and comprises a substrate 10 of which is printed an instant win game including game data 11 covered by a removable scratch off layer 12 by which the player can reveal the game data and play the instant win game. The game data may be complex and involve more than one section of game data covered altogether or separately by scratch-off layers or as is well known to one skilled in the art. The ticket includes further information including a logo identifying the lottery authority as indicated at 13, game instructions or information as indicated at 14, again number as indicated at 15 and a machine readable code 16 covered by a scratch-off layer 17. The machine readable code may be provided either under the same scratch-off box as the game data or under its own separate scratch-off box, as is well known.

The ticket may further include a further number indicated at 18 which can be hidden under the scratch-off layer either of the game data or of the machine readable code.

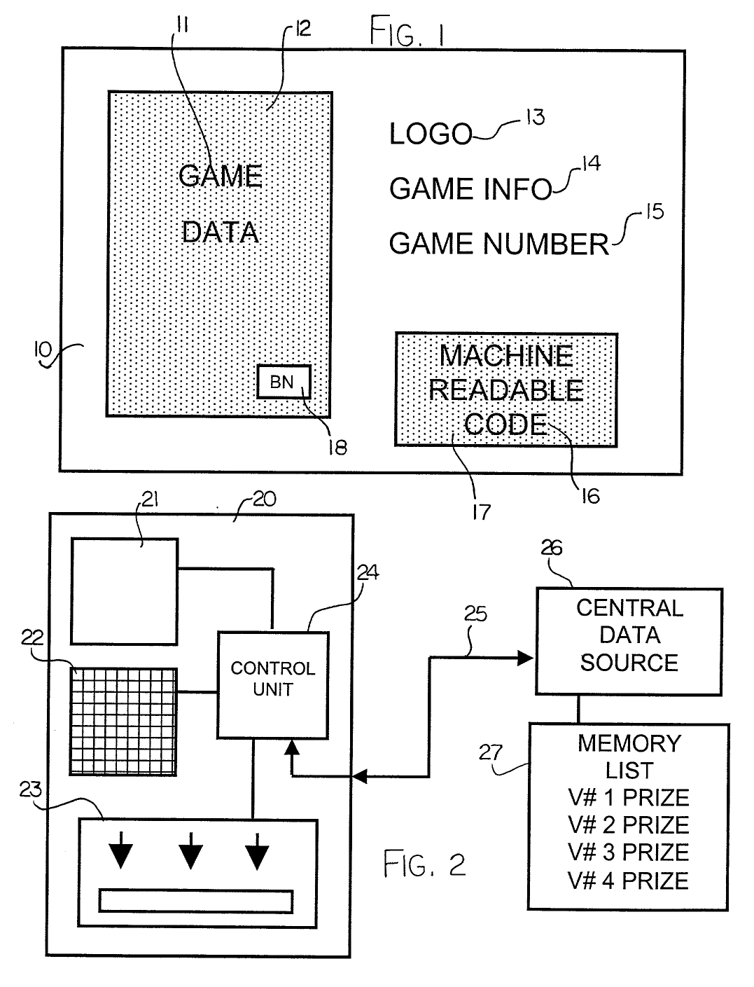

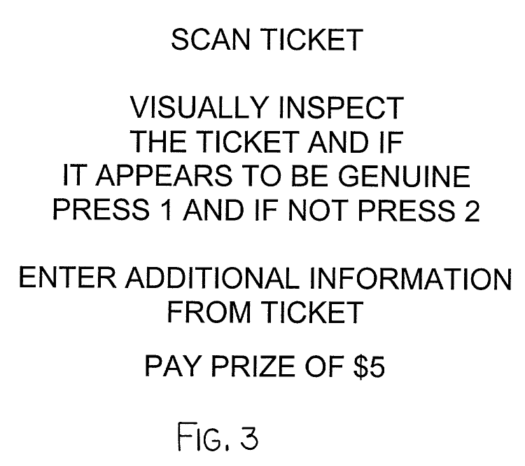

A conventional validation terminal is shown in FIG. 2 and comprises a housing 20 which includes a screen 21 for displaying information to the agent or clerk, a keypad 22 by which the agent may insert numbers or data as instructed, a code reader 23. All of these elements are connected to a control unit 24 within the validation terminal and that control unit communicates through a communications link 25 to a central data source 26. In the alternative the information from the central data source may be provided actually in the terminal itself so as to avoid the telecommunications link 25. The central data source includes a memory 27 which carries a list of validation numbers relative to a prize to be paid in association with that validation number.

It will be appreciated in this regard that of course the instant win ticket has game data which is predetermined to form a losing ticket or predetermined to win a prize of a predetermined amount. Thus the individual game data associated with the ticket is also associated with a validation number which is printed on the ticket as the machine readable code so that the lottery can carry in the memory of the central data source the list of tickets which are winning tickets and the prize associated therewith.

The process of validation therefore includes the following steps:

1. A customer on finding an allegedly winning ticket presents it to the agent for payment of the prize associated with that ticket.

2. The agent is prompted by the screen 21 to effect scanning of the ticket. In order to effect the scanning, it may be necessary for the agent to remove the scratch-off layer 17 over the machine readable code 16. The coating 17, on some cases, is covered by the instruction “void if removed” and this provides a level of security as is well known to a person skilled in the art as described in the above prior art patents. However this is not essential and the machine readable code may be located under the game scratch-off or may simply be exposed. The scanning action is effected by inserting the ticket into the scanner 23. Different types of scanner can be used but primarily the scanner is preferably a laser type scanner which effects a scanning action of a bar code type machine readable code without the necessity for contact between the laser scanner and the bar code itself. Such scanners are well known and are widely used and can read various types of bar code or machine readable code as required.

The type of machine readable code can be any arrangement of characters or markings which are set out to provide readable data in a manner which can be readily scanned using the type of scanner available, as is well known to one skilled in the art.

The effect of scanning the ticket provides data communicated from the scanner 23 to the control unit 24 which is then communicated through the telecommunications link 25 to the central source as a query providing the scanned data which forms the validation number and requesting information as to whether that validation number applies to a winning ticket and if so what prize amount is associated with that ticket.

3. However before the prize winning data is communicated via the screen 21 to the agent, a further prompt is provided to the agent on the screen 21 which requests information from the agent as to whether the agent has visually inspected the ticket and ensured that it appears to be on its face to be a genuine ticket. The agent is prompted to press a certain key if it is believed to be genuine and another key if it is believed not to be genuine. This step does not require that the agent carry out any action to validate the ticket but merely to ensure that the agent has inspected the ticket sufficiently to ensure that it appears to be a lottery ticket with scratch-off materials as oppose to a photocopy or even as oppose to a simple piece of paper carrying only the machine readable code. This action is used to prompt unmotivated, untrained or otherwise ineffective agents to carry out the required visual inspection.

4. A further prompt to the agent provides on the screen after the above step requires the input of an additional piece of information taken from the ticket. One example of the additional information may simply comprise the game number which is readily available printed on the front face of the ticket. This would ensure that the game number printed on the ticket corresponds to the game number obtained from the machine readable code to protect against fabricated tickets put together from different parts. Another example of information which can be taken from the ticket may be more secret information such as the number indicated at 18. Thus for example the agent may be prompted to enter the “number printed in blue at the bottom of the game data”. This information may therefore vary for different tickets of the game series and may be available only after the game has been played by removing the scratch-off layer 12.

It will be appreciated that the system has the potential for requesting different data from different game series so that neither the clerk nor the customer will be aware of exactly what additional information will be required to be entered in addition to the scanning action of the validation number.

The additional Information required beyond the scanned validation number may include all of the above or only one element of the above. The point is that the act of authentication of the ticket is improved by the fact that more information is provided than simply the scanned validation number. This information may be provided by the clerk merely visually inspecting the ticket or may be provided by the clerk removing and entering numbers or other data from the ticket. The information does not need to be numerical but could simply be an answer to a question relating to the ticket, such as “is the game data printed in blue”.

The additional information may be stored in the memory 27 in association with the validation number or may be stored at the terminal 20 itself.

While the preferred embodiments of the invention have been described above, it will be recognized and understood that various modifications may be made therein, and the appended claims are intended to cover all such modifications which may fall within the spirit and scope of the invention.

1. A method comprising:
providing a series of instant win lottery tickets having game indicia thereon for playing by a player, the tickets being associated together as a game identified by a game number printed on each ticket of the series, some of the tickets being winning tickets having a predetermined prize value and some of the tickets being losing tickets;
providing on each ticket of the series a validation number unique to the ticket which is printed on the ticket in machine readable format;
providing a data source having for all the winning tickets a list of the validation numbers in association with a predetermined prize value of the associated ticket;
in the event that an alleged winning ticket is presented for payment of a prize by a player, causing an agent to receive the alleged winning ticket;
providing a validation terminal;
providing at the terminal having a scanner for reading the validation number in machine readable format;
providing at the terminal a communications link to the data source;
providing at the terminal a manual input device operable by the clerk to enter information;
providing at the terminal an output device for communicating information to the agent;
causing the agent at the terminal to scan the ticket using the scanner to read the validation number;
causing the output device to communicate information to the agent requiring input of required information from the alleged winning ticket;
and, only upon receipt of the required information and upon the scanned validation number properly appearing on the list of winning tickets at the data source, authorising payment to the player of the predetermined prize value associated with that validation number.

2. The method according to claim 1 wherein the input device comprises a manual key pad.

3. The method according to claim 1 wherein the output device comprises a display screen.

4. The method according to claim 1 wherein the required information comprises a number printed on the ticket.

5. The method according to claim 4 wherein the number is the game number.

6. The method according to claim 1 wherein the required information is a confirmation that the agent has inspected the ticket and confirms that it appears on its face to be a valid ticket.

7. The method according to claim 6 wherein the required information also includes a number printed on the ticket.

8. The method according to claim 7 wherein the number is the game number.

9. The method according to claim 1 wherein the validation number is in bar code format.

10. The method according to claim 1 wherein the validation number is a void if removed number (VIRN) covered by a scratch-off layer.
